(19) United States
(12) Patent Application Publication
(10) Pub. No.: US 2001/0024685 A1
(43) Pub. Date: Sep. 27, 2001

(54) Method for forming a protective coating and substrates coated with the same

(76) Inventors: Jonathan M. Boulton, Tucson, AZ (US); Syed Masood Hassan, Tucson, AZ (US); Catherine A. Getz, Holland, MI (US)

Correspondence Address: FITZPATRICK CELLA HARPER & SCINTO, 30 ROCKEFELLER PLAZA, NEW YORK, NY, 10112, US

(21) Appl. No.: 09/808,172

(22) Filed: Mar. 15, 2001

Related U.S. Application Data
(62) Division of application No. 09/099,035, filed on Jun. 18, 1998.
(60) Provisional application No. 60/050,181, filed on Jun. 19, 1997.

(51) Int. Cl. B05D 1/36; B05D 3/02; B05D 5/06

(52) U.S. Cl. 427/162; 427/376.2; 427/419.2

(57) ABSTRACT

This invention is a substrate with a protective multicomponent coating, and a method for forming such a substrate by the steps of applying a coating solution to the substrate, and firing the substrate at a temperature greater than 450° C., where the coating solution includes a coating solvent; a SiO₂ precursor being a silicon compound having at least one hydrolyzable group; a glass oxide precursor being a compound of an element selected from Group III or Group IV of the periodic table; and a network modifier precursor being a compound of an element selected from Group I or Group II of the periodic table. The invention is also related to the coating solution employed in the method of the invention.

This application claims the benefit of U.S. Provisional application Ser. No. 60/050,181, filed Jun. 19, 1997.

### BACKGROUND OF THE INVENTION

1. Field of the Invention

This invention relates to a method for preparing a protective multicomponent oxide coating on a substrate using a coating solution containing a coating solvent, an SiO₂ precursor, a glass oxide precursor, and a network modifier precursor. The coating solution is fired at a temperature greater than about 450° C. to form the protective coating. The method of this invention provides coatings that are particularly abrasion resistant. The invention also relates to coated substrates such as touch-screen displays prepared by the method of this invention and the coating solution used thereon.

2. Related Background Art

Sol-gel or wet chemical approaches have been widely used to obtain high quality coatings of single and multicomponent oxides. Coatings can be prepared from liquid precursor solutions using simple spin, spray or dip coating techniques. See, e.g., C. J. Brinker and G. W. Scherer, “Sol-Gel Science—The Physics and Chemistry of Sol-Gel Processing”, Academic Press, 1990. Despite the attractiveness of the technique for film fabrication, severe cracking of the film is generally encountered when attempting to prepare coatings thicker than 0.5 -1.0∥m in a single coat. Cracking on drying at ambient temperature is generally attributed to high capillary pressures produced as the liquid/gas interface of the evaporating solvent recedes into the gel structure. Additionally, on drying and subsequent firing, film shrinkage can only occur in the direction perpendicular to the substrate due to strong adhesion between the film and the substrate. This shrinkage results in high levels of tensile stress in the film parallel to the surface, which can lead to cracking. Consequently, sol-gel derived coatings generally have a low thickness threshold before cracking occurs.

With sol-gel derived SiO₂ coatings it has been found that cracking can be reduced by using silicon alkoxide precursors containing non-hydrolyzable organic groups, i.e., R′ₙSi(OR)₄₋ₙ, instead of conventional Si alkoxides, Si(OR)₄, where R═CH₃—, C₂H₅—, etc., and R′═CH₃—, C₆H₅—, etc. The incorporation of these non-reactive R′ groups has been suggested to reduce the overall connectivity of the gel network, producing a network with a degree of flexibility which enables the film to tolerate the stresses of drying.

For example, P. Innocenzi, Sol-Gel Optics III, SPIE Proc. Vol. 2288, 1994, p.87, “Methyltriethoxysilane coatings for optical applications”, describes the use of acid catalyzed solutions of MeSi(OEt)₃ and Si(OEt)₄ or Ti(OⁿBu)₄ to deposit SiO₂ or SiO₂—TiO₂ coatings by dipping or spinning. Crack-free coatings, up to 1.5 μm thick, were obtained after firing at 500° C. These coatings were used as matrices for metallic nanoparticles.

M. Mennig, G. Jonschker and H. Schmidt, Sol-Gel optics II, SPIE Proc. Vol.1758, 1992, p. 125, “Sol-gel derived thick coatings and their thermomechanical and optical properties”, describes the preparation of crack-free, transparent SiO₂ coatings, up to 8 μm thick, after firing to 500° C. These coatings were obtained from an 80:20 mixture of MeSi(OEt)₃ and Si(OEt)₄, together with an aqueous colloidal SiO₂ solution. This reference suggested employing this coating in the field of planar waveguides and for the thermal protection of flat glass.

Similar methods are also widely used for spin-on-glass (SOG) technology in the semiconductor industry. See, e.g., S. K. Gupta, Microelectronic Manufacturing and Testing, April, 1989, “Spin-on glass for dielectric planarization”. SOG materials are used as sacrificial layers in etch-back processes and as permanent dielectric layers due to their good insulating and planarizing properties. Commonly, SOG materials are prepared via the hydrolysis of an alkyltrialkoxysilane, an aryltrialkoxysilane or from a mixture of a tetraalkoxysilane and an alkyltrialkoxysilane or aryltrialkoxysilane (typically methyl or phenyl) to form a polysiloxane polymer (known as a polysiloxane SOG material). See, e.g., S. G. Shyu, T. J. Smith, S. Baskaran and R. C. Buchanan, Mater. Res. Soc. Symp. Proc. Vol. 121 (1988) p. 767, “Investigation of processing parameters on stability of SOG coatings on patterned Si wafers”. A typical SOG process begins with spin-coating a Si wafer at 3000-7000 rpm for 20-30 seconds. After a low temperature stabilization step (90-120° C.), the film is processed at a sequence of increasing temperatures in the 180-450° C. range. Typically, SOG materials can be used to give coatings as thick as 0.4 μm without cracking and the film uniformity over a 6 in. wafer can exceed 1%. The maximum temperature at which many SOG coatings are cured is 450° C. due to the presence of Al interconnects in the underlying structure. After such a low temperature cure the film usually contains significant amounts of residual ≡Si —OH and organic groups, with the temperatures being insufficient to completely oxidize the ≡Si—C≡ bonds in the SOG film.

The use of silicon alkoxides containing non-hydrolyzable organic groups has also been widely used to prepare abrasion resistant coatings on plastic substrates, e.g., polycarbonate and acrylic lenses. In these instances the coatings are fired at relatively low temperatures (typically below 200° C.) to protect the thermally sensitive substrate. Under such firing conditions, the non-hydrolyzable organic groups on the Si atoms remain intact so the final coating can be regarded as an organic-inorganic composite material.

For example, U.S. Pat. No. 3,986,997, describes the use of SiO₂ based coating compositions containing colloidal SiO₂ and silanes of the type R′Si(OR)₃. After deposition, the coatings on plastic are cured at temperatures in the range of 75-125° C. (or on ceramic heat exchanger cores at 350° C. for 20 hrs). The use of coatings based on colloidal TiO₂, colloidal SiO₂, and a silane of the type R′Si(OR)₃ is described in U.S. Pat. No. 4,275,118. These coatings, which are cured in the range of 50°-150° C., are useful as abrasion resistant coatings that absorb ultraviolet light.

Other examples include coating compositions prepared by hydrolyzing an alkyltrialkoxysilane or aryltrialkoxysilane in an aqueous colloidal SiO₂ dispersion which contained a small amount of an ultraviolet absorbing compound, such as described in U.S. Pat No. 4,299,746. These coatings are cured at 75°-200° C. U.S. Pat. No. 4,405,679 is directed to coatings containing: (a) at least one hydrolysate selected from the group of epoxy group-containing silicon compounds, (b) at least one member selected from the group consisting of hydrolysates of organic silicon compounds, colloidal SiO₂ and organic titanium compounds, and (c) a curing catalyst. These coatings are deposited on polycarbonate articles and fired at temperatures below 130° C. Yet another example includes U.S. Pat. No. 4,500,669, which describes transparent, abrasion resistant coating compositions comprising a partial condensate of compounds of the type R′Si(OH)₃ and a colloidal dispersion. Such coatings are cured at temperatures of 65°-130° C.

Multicomponent silicate-based glasses are well known materials useful for a large number of applications. Typical oxides incorporated in SiO₂ to form multicomponent oxide glasses are other network formers and intermediates, e.g., B₂O₃ and Al₂O₃, and network modifiers, e.g., Na₂O and Li₂O. Network formers, intermediates, and modifiers, and a listing of such oxides, are described by Kingery, W. D., et al. Introduction To Ceramics (John Wiley & Sons, 1976, Chapter 3), the disclosure of which is incorporated by reference herein. As compared to silica, multicomponent silicate glasses can be processed at much lower temperatures due to their reduced viscosity, e.g., pure SiO₂ has a softening point of ≈1670° C. compared to that of ≈820° C. for a Pyrex borosilicate glass as described by N. P. Bansol, et al., Handbook of Glass Properties (Academic Press, 1986, Chapters 2 & 3). Glasses based on Al₂O₃—B₂O₃—Na₂O—SiO₂ mixtures (the well known Pyrex borosilicate glasses) are used on an enormous scale industrially.

A method for preparing thick, crack-free, multicomponent silicate-based glass films from solution which provide films exhibiting much improved properties compared to pure solution-derived SiO₂ films, particularly in terms of abrasion resistance, when fired at relatively low temperatures (approximately 500° C.), would be highly desired.

### SUMMARY OF THE INVENTION

This invention is directed to a method for forming a protective multicomponent coating on a substrate. In particular, a multicomponent silicate based coating solution is deposited on a substrate. After deposition the material is fired at a sufficiently high temperature, i.e., about 450° C. or greater, (>450° C.) to decompose the residual organic groups and to densify the coating, thus imparting the desired abrasion resistance and protective properties. Coatings fired at lower temperatures exhibit relatively poor performance. The coating thickness after firing typically exceeds 0.5 μm and is preferably in the range of 0.5-3.0 μm. The coating solution can be applied by wet chemical deposition coating methods such as spin, dip, spray, roller or meniscus coating.

Yet another embodiment of this invention is directed to the coating solution employed in the method of this invention. This coating solution contains at least one SiO₂ precursor which is a silicon compound having at least one hydrolyzable group. Preferably, this SiO₂ precursor is an alkyl or aryl trialkoxysilane and, if desired, a tetraalkoxysilane. The coating solution also contains at least one glass oxide precursor which is a compound having an element selected from Group III or Group IV of the periodic table. Such glass oxide precursors, which are typically alkoxides, salts, hydroxides or acids, form a multicomponent oxide glass film on firing in order to obtain the desired abrasion resistance. Other elements can be incorporated in any form which is soluble in the coating solution. The coating solution also contains at least one network modifier precursor which is a compound containing an element selected from Group I or Group II of the periodic table. Typically the network modifier precursor takes the form of a hydroxide, an acetate, or an alkoxide.

The constituents of the coating solution are mixed in any suitable volatile solvent, such as an alcohol, ketone, ester, hydrocarbon, or combination thereof. The precursors are reacted with water and preferably a catalyst to pre-polymerize them prior to their deposition. After deposition the coatings are fired at a sufficiently elevated temperature to densify the coating. Preferred coating compositions are based on multicomponent silicate glasses, e.g., Al₂O₃—B₂O₃—Na₂O —SiO₂, Al₂O₃—B₂O₃—Li₂O—SiO₂, and Al₂O₃ —B₂O₃ —Li₂O —Na₂O—SiO₂ and Al₂O₃—Na₂O —SiO₂.

This invention is also directed to substrates having a protective multicomponent coating prepared using the method as described above. Examples of such substrates include bent substrates for cathode ray terminal (CRT) touch screens, flat substrates for liquid crystal display (LCD) touch screens and other display terminals. This invention may also be used for substrates which provide touch-screen functionality and are an integral part of the display themselves.

### BRIEF DESCRIPTION OF THE DRAWINGS

FIG. 1 is a side view of one embodiment of a protectively coated substrate of this invention.

FIG. 2 is a side view of another embodiment of a protectively coated substrate of this invention.

### DETAILED DESCRIPTION OF THE INVENTION

The method of this invention is directed to the formation of a protective multicomponent coating on a substrate using a coating solution, containing an SiO₂ precursor. The SiO₂ precursor is represented by R′ₙSi(Y)₄₋ₙ, where n=1-3. Y is any hydrolyzable group. R′ is an alkyl, aryl or any other non-hydrolyzable group. The term “alkyl” means a straight, branched or cyclic group having 1 to 20 carbon atoms, any of which may be unsubstituted or substituted. The term “aryl” means an aromatic ring having 6 to 30 carbon atoms, any of which may be unsubstituted or substituted. Possible substituents include, but are not limited to, halogen, hydroxy, alkoxy, aryloxy, epoxy, vinyl, mercapto, ureido, methacryloxy, amino and substituted amino. The term “non-hydrolyzable” means substantially unreactive with water under the conditions of temperature, pressure, concentration and pH used in preparing the coating solution. The term “alkoxy” means an alkoxy group containing an alkyl group as defined above. The term “aryloxy” means an aryloxy group containing an aryl group as defined above.

Exemplary hydrolyzable groups include hydrogen, halo, amino, amino alkyl, alkoxy, aryloxy, alkyl carboxyl, aryl carboxyl, —OC(═CH₂)R², and —ON═CR²₂ wherein R² is alkyl or aryl. However, as a matter of convenience the preferred hydrolyzable group is an alkoxy group, i.e., the SiO₂ precursor is represented by Rₙ′Si(OR)₄₋ₙ, where R is an alkyl group. For Rₙ′Si(OR)₄₋ₙ, any alkyl or aryl substituted alkoxysilane can be used, but for reasons of cost the methyl substituted compounds, i.e., CH₃Si(OCH₃)₃ and CH₃Si(OC₂H₅)₃ are preferred, as they are generally the least expensive of the substituted alkoxysilanes and have the lowest molecular weight, i.e., the highest equivalent SiO₂ content. The entirety of the SiO₂ can be derived from the substituted alkyl trialkoxysilane.

Alternatively, if desired, the SiO₂ precursor is a combination of a substituted alkyl trialkoxysilane and a silicon compound of the form SiY₄, where Y is a hydrolyzable group. For reasons of cost and availability Si(OC₂H₅)₄ and Si(OCH₃)₄ are preferred. However, in addition to tetraalkoxysilanes, any Si compound which contains 4 hydrolyzable groups can be used, e.g., compounds of the type SiCl₄ and Si(OCOCH₃)₄. In addition, any of the starting Si compounds can be pre-polymerized prior to use, i.e., oligomeric or polymeric Si precursors are suitable. Commercially available examples are poly(methylsilsesquioxane) and poly(diethoxysiloxane) [also known as technical ethyl silicate].

The SiO₂ precursor is typically present in the coating solution in an amount from about 4 wt. % to about 66 wt. %, preferably from about 22 wt. % to about 33 wt. % of the total weight of the coating solution.

The coating solution also contains a glass oxide precursor comprising a compound having an element selected from Group III or Group IV of the periodic table. Aluminum and boron compounds are particularly preferred. Typically these precursors take the form of a salt, an alkoxide, hydroxide or an acid. However, any soluble precursor can be used.

For example, a B₂O₃ precursor in the form of a boron alkoxide such as triethyl borate, B(OC₂H₅)₃, can be used, or alternatively boric acid, B(OH)₃, may be used. For an Al₂O₃ precursor, an alkoxide or a soluble salt can be used, e.g., aluminum iso-propoxide, Al(OiC₃H₇)₃, aluminum sec-butoxide, Al(O^{s}C₄H₉)₃, etc., or salts such as AlCl₃·6H₂O, Al(NO₃)₃ 6H₂O or aluminum chlorohydrate, Al₂(OH)₅Cl·2H₂O. If an aluminum alkoxide is used it can be modified to provide enhanced stability. Suitable modifiers are chelating agents such as 2,4-pentanedione, ethylacetoacetate, and acetic acid. Other modifiers that are known to reduce the sensitivity of metal alkoxides to water, such as alkanolamines, may also be used. Useful commercially available aluminum alkoxides include, for example, aluminum di(iso-propoxide) acetoacetic ester chelate, Al (OⁱC₃H₇)₂(C₆H₉O), and aluminum di(sec-butoxide) acetoacetic ester chelate, Al (O^{s}C₄H₉)₂(C₆H₉O).

Each glass oxide precursor is generally present in the coating solution in an amount from about 0.2 wt. % to about 34 wt. %, preferably from about 1 wt. % to about 17 wt. % of the total weight of the coating solution.

The coating solution employed in this invention also contains a network modifier precursor, which is a compound containing an element selected from Group I or Group II of the periodic table. Where such a network modifier precursor is an alkali metal oxide, suitable examples include hydroxides (e.g., NaOH and LiOH·H₂O), acetates, and alkoxides. Any soluble precursor may be used. Each network modifier precursor is typically present in an amount from about 0.1 wt. % to about 2.0 wt. %, preferably from about 0.4 wt. % to about 1.0 wt. % of the total weight of the coating solution.

In addition to the incorporation of the above-noted precursors, such as soluble alkoxides and salts, other materials can also be incorporated into the coating solution to produce desired effects. Examples of components that may be incorporated include oxide or non-oxide particles and pigments. Non-soluble particles can be added as solid materials or as colloidal solutions. If desired, more than one kind of particles may be incorporated into a coating. Specific examples include electroconductive powders based on antimony-doped tin oxide (e.g., the Zelec® ECP range of powders sold by E. I. DuPont de Nemours, Wilmington, Delaware), high refractive index particles (e.g., Nyacol® colloidal zirconia solutions sold by PQ Corp. Valley Forge, Pa.), low refractive index particles of magnesium fluoride, and silica particles, either as an aqueous solution (e.g., the Ludox® range sold by E. I. DuPont de Nemours, Wilmington, Del.), an organic solution (e.g., Snowtext® IPA-ST as sold by the Nissan chemical Company, Tarrytown, N.Y.) or as a solid fumed (e.g., Aerosil® range) or precipitated silica (e.g., Ultrasil® VN3 SP) available from Degussa, Rigefield Park, N.J.). Particles can be incorporated to modify the refractive index of the coating, for coloration, to produce scattering phenomena, or to impart electrical conductivity, change dielectric constant, etc. These particles could simultaneously modify more than one of these properties of the coating.

The refractive index of the coating is important in determining the surface reflectivity, interference colors and patterns from the underlying substrate. The refractive index of the coating can be tailored and controlled by an appropriate choice of composition. For example higher refractive indices may be obtained by the incorporation of oxides of Pb, Ba and Ti. On the other hand, the refractive index of the coating may be reduced by the introduction of MgF₂ particles or by the introduction of a certain degree of porosity. This -may be also influenced by other coatings that may have been deposited earlier on to the substrate. The choice of refractive index and thickness may lead to coatings with anti-reflective properties, elimination of iridescent colors from interference, etc. (Thin Film optical Filters, H. A. Mcleod, Chapter 3, McGraw-Hill Publishing Co., 1989). If the coating refractive index is matched to the underlying substrate layer (or a coating), the number of optical interfaces is minimized. The size, shape, loading and the refractive index of the particles incorporated in the coatings can be selected to give anti-glare properties (Introduction to Ceramics, W. D. Kingery, H. K. Bowen and D. R. Uhlmann, Chapter 13, John Wiley and Sons, 1976). The processing conditions may be chosen so that even without external particulate addition, the homogenous coating solution forms a two phase structure when coated, thus resulting in anti-glare properties. One such method is described in copending U.S. patent application Ser. No. 08/282,307 (Catherine Getz and D. Varaprasad of the Donnelly Corporation, Holland, Mich.), the disclosure of which is incorporated by reference herein.

It is generally preferred that the SiO₂ precursor, e.g. a substituted alkoxysilane, be added to an organic solvent, and then pre-hydrolyzed by the addition of water and a hydrolysis catalyst. The organic solvent can be any suitable solvent, such as an alcohol, ester, ketone or hydrocarbon. Mixtures of different solvents with different boiling points can be used to produce a film where the individual solvents evaporate at different times during the drying process, thereby reducing the overall drying stresses experienced by the film. At this or a latter stage, various additives can be added to improve the quality of the film (e.g., surfactants, defoamers, air release additives, flow aids, viscosifiers, etc.). The ratio of SiO₂ precursor to solvent is chosen to give a sufficient oxide loading to prepare the desired film thickness. Typically an SiO₂ precursor to solvent weight ratio of 1:1 to 1:3 is used, although this ratio may be adjusted by the introduction of thickening agents.

In addition, it is preferred that the SiO₂ precursor is pre-hydrolyzed by the addition of water in the ratio of 0.33 - 1 moles water to 1 mole of hydrolyzable group, although different ratios can be used. To obtain a sufficiently fast rate of reaction a catalyst may be added to promote the reaction. For example, many substances are known to promote the hydrolysis of alkoxysilanes. Commonly, these catalysts are mineral acids. Other examples are acetic acid, ammonium hydroxide, potassium hydroxide, amines, hydrofluoric acid, fluoride salts, metal alkoxides, tin compounds, iron compounds, lead compounds and metal oxides. Preferably an acidic catalyst, e.g., dilute hydrochloric acid is used. In such a case, the alkoxysilane is reacted with water for a sufficient length of time to produce a significant number of silanol groups; this can be performed at room temperature or at elevated temperature. After this stage, other desirable components can be added, either sequentially or together. For compositions containing alkali metal hydroxides, it is preferred that they are added as the final step. Additional water or hydrolysis/condensation catalysts can also be added at the end of the reaction. Latent condensation catalysts can also be added at this stage. Such latent catalysts are known to those skilled in the art. Suitable examples include alkali metal salts of carboxylic acids, e.g., sodium acetate, potassium formate and the like, amine carboxylates, such as dimethylamine acetate, ethanolamine acetate, dimethylaniline formate, and the like, and quaternary ammonium carboxylates, such as tetramethyl ammonium acetate, and the like. For compositions containing boric acid it is preferable to react the boric acid with the alkoxysilane prior to any other reaction. This can be done at room temperature or at elevated temperature, and catalysts can be added to increase the rate of this reaction.

After the coating solution is prepared, it can be deposited onto a substrate by spin or dip coating, or using any other technique that will provide a relatively uniform film on a substrate. To avoid the introduction of defects into the coating this procedure is best performed under filtered air, and the solution should be filtered before deposition. The coating procedure can also be performed under a controlled humidity atmosphere. The deposition process and coating solution concentration are optimized so as to give a sufficiently thick coating. Such optimization is readily performed by one of ordinary skill in the art without undue experimentation. After coating, the coating solution is generally allowed to dry by evaporation of the volatile solvents, and then fired at an elevated temperature to bring about densification, thus imparting the desired hardness to the film. Firing temperatures in excess of about 400° C., preferably about 450° C., are satisfactory for producing abrasion resistant coatings. Typically the firing temperatures range from about 400° C. to about 1200° C., preferably about 470° C. to about 700° C., most preferably 500° C. to 600° C. The furnace atmosphere should be oxidizing, i.e., it should contain air or oxygen, to aid in the burn-out of residual organic groups. Ozone or water/steam can also be introduced during firing to aid in burn-out.

After firing, a thick, crack-free, abrasion resistant, transparent multicomponent oxide glass coating is formed. The glass coatings are useful for the protection of various materials from external effects, such as mechanical wear (i.e., scratch resistance, abrasion resistance and wear resistance) and environmental attack (i.e., corrosion resistance, chemical resistance, and passivation). Exemplary substrates are those based on glasses, ceramics and metals, i.e., the substrate has the ability to tolerate the required firing temperature without undesirable effect. Such glasses include soda lime glass, boro-silicate glass and the like. A particularly useful application of the present coating is as a protective, abrasion resistant overcoat for the face-plates of cathode ray tubes used in touch-screen displays.

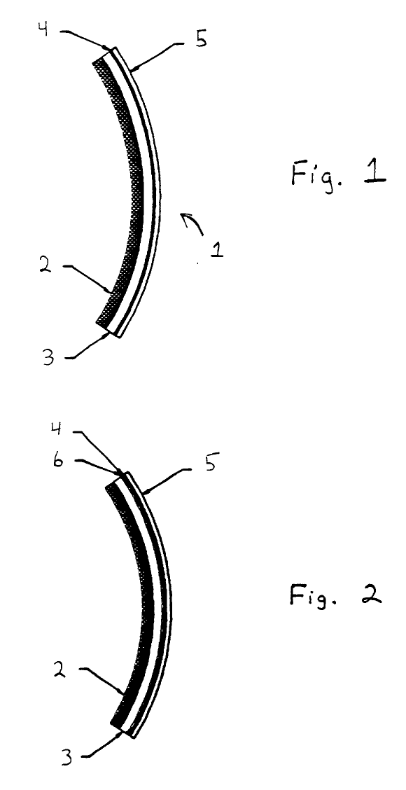

FIG. 1 illustrates a protectively coated substrate 1 of this invention having a CRT display 2 with a clear glass overlay 3 integrated thereon. A transparent conductor 4, which is deposited on the clear glass overlay 3, is covered by a protective multicomponent coating 5. FIG. 2 illustrates another protectively coated substrate of this invention similar to that illustrated in FIG. 1, with the exception that an anti-glare coating 6 resides on the clear glass overlay 3 beneath the transparent conductor 4. Examples of transparent conductors are antimony doped tin oxide, fluorine doped tine oxide, tin doped indium oxide and aluminum doped zinc oxide.

Abrasion testing of selected coatings deposited on conductive substrates (Sb-doped SnO₂ coated glass cathode ray tube (CRT) face-plates and tin doped indium oxide coated glass) was performed. This test consisted of 3000 cycle increments of linear abrasion using an eraser insert (MIL-E- 12397B) and 2.5 pounds of force. After 3000 cycles, the sample was cleaned and a continuity tester with a probe gap of ⅛ inches was placed on the abraded area in the direction of the stroke. Testing was then continued until failure (approximately 100 k Ω). In general, the abrasion resistant coatings of this invention exhibited good performance in terms of protecting the underlying transparent conductor after at least 25,000 cycles.

The examples which follow are intended as an illustration of certain preferred embodiments of the invention, and no limitation of the invention is implied.

### EXAMPLE 1

Coatings of the following nominal composition were prepared:

| Oxide | Weight % |
|---|---|
| SiO₂ | 65 |
| B₂O₃ | 27 |
| Al₂O₃ | 5 |
| Na₂O | 2 |
| Li₂O | 1 |

10.0 g of CH₃Si(OCH₃)₃, 20.0 g of solvent (containing the following by weight percent: ethyl acetate (25.8), ethanol (20.0), methanol (23.3), acetone (28.3), 2,4-pentanedione (1.2), 1-pentanol (1.4)), and 2.65 g of 0.15M HCl were combined. The solution was aged for 10 minutes and then 7.67 g of B(OC₂H₅)₃ was added. After 20 minutes 1.83 g of Al(OⁱC₃H₇)₂C₆H₉O₃ pre-reacted with 0.67 g of 2,4-pentanedione, was added and the solution was aged for 20 minutes. A NaOH-LiOH solution was added. This solution was prepared by dissolving 0.18 g of NaOH and 0.19 g of LiOH·H₂0 in 2.0 g of the solvent mixture described above. The coating solution was spin-coated on a convex surface of a conductively coated CRT face-plate used for touch-screen technology (available from Donnelly Information Products, Holland, Mich.) and on the conductive side of a flat piece of TEC 15 (conductively coated glass available from Libby Owens Ford Company, Toledo, Ohio). The samples were heated from room temperature to 500° C. at a rate of 10° C./minute and kept at 500° C. for 1 hour. After firing, the coating thickness determined by profilometry (Tencor Instruments α-Step 200, Mountainview, California) was 1.06 μm on the TEC 15 substrate. The coated CRT face-plate had an abrasion resistance of 60,000 cycles.

### EXAMPLE 2

Coatings of the following nominal composition were prepared:

| Oxide | Weight % |
|---|---|
| SiO₂ | 81 |
| B₂O₃ | 12 |
| Al₂O₃ | 2.5 |
| Na₂O | 4.5 |

10.0 g of CH₃Si(OCH₃)₃, 15.0 g of solvent (containing the following by weight percentage: ethyl acetate (25.8), ethanol (20.0), methanol (23.3), acetone (28.3), 2,4-pentanedione (1.2) and 1-pentanol (1.4)), and 2.65 g of 0.15M HCl were combined. The solution was aged for 10 minutes and then 2.74 g of B(OC₂H₅)₃ was added. After 20 minutes 0.73 g of Al(OⁱC₃H₇)₂C₆H₉O₃ and 0.27 g of 2,4-pentanedione was added, and the solution was aged for 20 minutes. A NaOH solution was added. This solution was prepared by dissolving 0.32 g of NaOH in 2.0 g of the solvent described above. The coating solution was aged for 20 minutes and then spin-coated on a CRT face-plate and a flat piece of TEC 15, and fired at 500° C. for 1 hour at a heating rate of 10° C./minute. After firing, the coating thickness on the TEC 15 was determined by profilometry to be 1.50 μm. The coated CRT face-plate had an abrasion resistance of 102,000 cycles.

### EXAMPLE 3

Coatings of the nominal composition described in Example 2 were prepared, but in this case boric acid was used as the B₂O₃ precursor. 10.0 g of CH₃Si(OCH₃)₃, 1.16 g of B(OH)₃, and one drop 0.15M HCl were combined and refluxed for 2 hours. 15.0 g of solvent (containing the following by weight percentage: ethyl acetate (75.6) and methanol (24.4)) and 2.65 g of 0.15M HCl were added and the solution stirred for 30 minutes. Then, 0.73 g of Al(OⁱC₃H₇)₂C₆H₉O₃ and 0.27 g of 2,4-pentanedione (pre-reacted for 20 minutes) were added. After a further 20 minutes, a solution of 0.32 g NaOH dissolved in 2.0 g of methanol was added. The resulting solution was aged for 1 hour and then spin-coated on a CRT face-plate at 375 rpm. The coated face-plate was then fired at 500° C. for 1 hour using a heating rate of 10° C./minute. After firing, the coating thickness determined by profilometry was 1.47 μm on the TEC 15 substrate. The coated CRT face-plate had an abrasion resistance of 141,000 cycles.

### EXAMPLE 4

Coatings of the nominal composition described in Example 3 were prepared, but in this case the B(OH)₃ and the CH₃Si(OCH₃)₃ were pre-reacted at room temperature rather than at elevated temperature.

Thus, 40.0 g of CH₃Si(OCH)₃, 4.64 g of B(OH)₃ and 4 drops of 0.1 M HCl were combined and stirred at room temperature for 3 days. 60.00 g of solvent (containing the following by weight percentage: ethyl acetate (75.6) and methanol (24.4)), and 10.58 g of 0.15M HCl were added to the solution and the solution was stirred for 30 minutes. Then 2.93 g of Al(OⁱC₃H₇)₂C₆H₉O₃ and 1.07 g of 2,4-pentanedione (pre-reacted for 20 minutes) were added. After a further 20 minutes a solution of 1.26 g NaOH dissolved in 8.0 g of methanol was added. The resulting solution was aged for 1 hour and then spin-coated on flat TEC 15 glass and a CRT face-plate. After firing at 500° C. for 1 hour at a heating rate of 10° C./minute the coating thickness was 1.71 μm on the TEC 15 substrate.

### EXAMPLE 5

Coatings of the following nominal composition were prepared:

| Oxide | Weight % |
|---|---|
| SiO₂ | 82.9 |
| B₂O₃ | 12.2 |
| Al₂O₃ | 2.6 |
| Na₂O | 2.3 |

100.0 g of CH₃Si(OCH₃)₃, 11.59 g of B(OH)₃ and 10 drops of 0.15M HCl were combined and refluxed for 2 hrs. 150.0 g of solvent (containing the following by weight percentage: ethyl acetate (75.6) and methanol (24.4)), and 26.45 g of 0.15M HCl were added and the solution stirred for 30 minutes. Then, 7.33 g of Al(OⁱC₃H₇)₂C₆H₉O₃ and 2.67 g of 2,4-pentanedione (pre-reacted for 20 minutes) were added. After a further 20 minutes, a solution of 1.58 g of NaOH dissolved in 20.0 g of methanol was added. The resulting solution was aged for 1 hour and then spin-coated on CRT face-plates at either 375 rpm or 750 rpm for 30 seconds.

A face-plate coated at 375 rpm was then fired at 500° C. for 1 hour using a heating rate of 10° C./minute. The abrasion resistance of this coating was 213,000 abrader cycles. A flat piece of TEC 15 coated under the same conditions gave a coating thickness by profilometry of 1.33μm.

Face-plates coated at 750 rpm were fired under different conditions and abrasion tested. A flat piece of TEC 15 coated under the same conditions, and fired at 500° C., was 0.97 μm thick. The abrasion resistance of this coating with firing temperature and time is shown below:

| Firing temperature | Firing time | Abrader cycles to |
|---|---|---|
| (° C.) | (minutes) | failure |
| 480 | 12 | 15,000 |
| 490 | 12 | 27,000 |
| 500 | 12 | 27,000 |
| 500 | 60 | 99,000 |

### EXAMPLE 6

Coatings of the following nominal composition were prepared:

| Oxide | Weight % |
|---|---|
| SiO₂ | 93 |
| Al₂O₃ | 5.4 |
| Li₂O | 1.6 |

49.0 g of CH₃Si(OCH)₃, 32.12 g of Si(OC₂H₅)₄, 108.9 g of solvent (containing the following by weight percentage: ethyl acetate (74.4), methanol (24.0) and 1-pentanol (1.6)), and 18.52 g of 0.15M HCl were combined and stirred at room temperature for 20 minutes. Then 9.6 g of Al(OⁱC₃H₇)₂C₆H₉O₃ and 3.5 g of 2,4-pentanedione (pre-reacted for 20 minutes) were added. After a further 20 minutes a solution of 1.47 g LiOH·H₂O dissolved in 32.4 g of methanol was added.

### EXAMPLE 7

Coatings of the following nominal composition were prepared:

| Oxide | Weight % |
|---|---|
| SiO₂ | 81.4 |
| B₂O₃ | 8.4 |
| Al₂O₃ | 6.3 |
| Na₂O | 2.6 |
| Li₂O | 1.3 |

70.0 g of CH₃Si(OCH)₃, 118.1 g of solvent (containing the following by weight percentages: ethyl acetate (33.6), methanol (26.1), acetone (36.9), 2,4-pentanedione (1.6) and 1-pentanol (1.8)), and 18.52 g of 0.15M HCl were combined and stirred at room temperature for 10 minutes. Then 13.35 g of B(OC₂H₅)₃ was added and the solution stirred for 20 minutes. Then 12.84 g of Al(Oⁱ C₃H₇)₂C₆H₉O₃ and 4.69 g of 2,4-pentanedione (pre-reacted for 20 minutes) were added. After a further 20 minutes a solution of 1.26 g NaOH and 1.38 g LiOH·H₂O dissolved in 35.9 g of methanol was added. The solution was coated on flat TEC 15 and fired to 500° C. for 1 hour. After firing the coating thickness determined by profilometry was 1.55 μm thick on TEC 15.

### EXAMPLE 8

Coatings of the nominal composition described in Example 7 were prepared, but in this case boron n-butoxide was used as the B₂O₃ precursor:

Thus, 23.33 g of CH₃Si(OCH)₃, 39.36 g of solvent (containing the following by weight percentages: ethyl acetate (33.6), methanol (26.1), acetone (36.9), 2,4-pentanedione (1.6) and 1-pentanol (1.8)), and 6.17 g of 0.15M HCl were combined and stirred at room temperature for 10 minutes. Then 7.01 g of B (OⁿC₄H₉)₃ was added and the solution stirred for 1 hour. Then 4.28 g of Al(OⁱC₃H₇)₂C₆H₉O₃ and 1.56 g of 2,4-pentanedione (pre-reacted for 20 minutes) were added. After a further 20 minutes a solution of 0.42 g NaOH and 0.46 g LiOH·H₂0 dissolved in 11.96 g of methanol was added. The solution was applied to TEC 15 and fired at 500° C. for 1 hour.

### EXAMPLE 9

Coatings of the nominal composition described in Example 7 were prepared, but in this case boric acid was used as the B₂O₃ precursor and acetic acid was added to the coating solution.

Thus, 70 g of CH₃Si(OCH)₃, 118.1 g of solvent (containing the following weight percentages : ethyl acetate (33.6), methanol (26.1), acetone (36.9), 2,4-pentanedione (1.6) and 1-pentanol (1.8)), and 18.52 g of 0.1 M HCl were combined and stirred at room temperature for 10 minutes. Then 5.65 g of B(OH)₃ was added and the solution stirred for 1 hour. Then 12.84 g of Al(OⁱC₃H₇)₂C₆H₉O₃ and 4.69 g of 2,4-pentanedione (pre-reacted for 30 minutes) were added. After a further 20 minutes a solution of 1.26 g NaOH and 1.38 g LiOH·H₂O dissolved in 35.9 g of methanol was added. After 2 hours 1.79 g of concentrated acetic acid was added. The solution was applied to TEC 15 and fired at 500° C. for 1 hour.

### EXAMPLE 10

Coatings of the following nominal composition were prepared:

| Oxide | Weight % |
|---|---|
| SiO₂ | 97 |
| Al₂O₃ | 1.5 |
| Na₂O | 1.5 |

10,256 g of CH₃Si(OCH₃)₃, 205 g of glacial acetic acid and 8,205 g of LUDOX® LS colloidal silica (a 30 weight % suspension in water manufactured by E. I. DuPont de Nemours, Wilmington, Del.) were combined with stirring and the resulting solution was aged for 72 hours.

Separately, 563 g of Al(OⁱC₃H₇)₂C₆H₉O₃ pre-reacted with 206 g of 2,4-pentanedione was combined with 121.5 g of NaOH pre-dissolved in 1,538 g of methanol. This solution was aged for 10 mins and then added to the aged CH₃Si(OCH₃)₃ colloidal SiO₂ solution. The resulting solution was aged for a further period of 24 hours after which 8,205 g of iso-propanol and 8,205 g of n-butanol were added to form a coating solution.

### EXAMPLE 11

A faceplate for use as a touchscreen on a computer monitor was fabricated using clear soda lime glass substrate. A flat clear glass lite of appropriate dimensions, 18 inches×23 inches×0.125 inches (45.7 cm×58.4 cm×0.318 cm) was purchased from PPG Industries of Pittsburgh Pa. A flat substrate in the general shape, slightly larger in dimension than a conventional 13 inch (33 cm) diagonal CRT screen was cut from the purchased flat glass lite. This flat shape was then bent to a spherical curvature of 22.6 inch (57.4 cm) spherical radius by press bending in a conventional glass bender by heating the clear glass in excess of about 550° C. and by press bending on a bending mold to the desired curvature resulting in a slightly oversized 13 inch (33 cm) faceplate. After bending, a thin conductive film coating of tin antimony oxide was deposited on the convex surface of the bent faceplate using vacuum deposition by sputtering. Thick film conductive material (for example, 7713 silver frit from Dupont Electronics, Wilmington, Del.) was applied by silk screen coating methods in patterns necessary to make contact electrodes for the sensor (additional thick film patterning and deletion of the thin film conductor may be required for the functional requirements of the specific touch technology utilized; such patterning and deletion is well known to those skilled in the art). This was followed by exposure to elevated temperatures in the range of 250° C. to about 500° C. in order to achieve desired optical, mechanical and electrical properties of the thick and thin film conductors. The resulting electrical sheet resistance of the thin film conductor was approximately 1800 ohms/sq. at a final transmission of approximately 82% as measured with four point probe resistance system and an optical integrating sphere. This conductively coated patterned faceplate was then washed using conventional means for substrate preparation for coating. Using a wet chemical dip method for sol-gel coating deposition at a withdrawal rate of approximately 0.9 inches/sec. (2.3 cm/sec.), the face plate was then coated with the formulation prepared in Example 10. (If desired, the substrate can be selectively coated by masking those areas in which coating may not be necessary, e.g., the back of the substrate. The masking can be achieved, for example, using tape, films, resin or the like.) The faceplate was then heated from ambient temperature up to 510° C. at a rate of approximately 10° C./min and fired at 510° C. for 1 hour. (If masking is employed, it may be removed after the coating step or heat treatment step as desired. In certain instances the heat treatment step may be used to burn off the masking.) Following firing, a coating thickness measurement was taken using a Dektak profilometer (Sloan Technology, Santa Barbra, Calif.). The film measured 2.2 μm. The coated CRT faceplate had an abrasion resistance of 70,500 cycles using the test method previously described. The tin antimony oxide coating under the protective overcoat was measured for electrical uniformity and optical transmission following the deposition and firing of the overcoat film. This electrical uniformity was measured by making electrical contact to the tin antimony oxide using the thick film conductive pattern deposited near the edges of the faceplate and the optical property with an integrating sphere. (Electrical contact can be made directly to the thick film conductor if masked prior to the addition of the protective overcoat. It is also possible to avoid masking or use other means of overcoat removal by soldering so that the solder could penetrate through the overcoat material to establish electrical contact with the electrode.) These measurements indicated no appreciable change in the underlying transparent conductor properties resulting from the processing and interaction of the overcoat material. To test for adequate coverage of the overcoat on the underlying transparent conductor, an electrical meter was used to attempt to make electrical contact to the tin antimony oxide. No electrical contact was made.

### EXAMPLE 12

As described in Example 11, faceplates for touch screens with anti-abrasion coatings were manufactured using anti-glare glass substrates. The anti-glare property was imparted to the glass substrates by using a conventional acid etch process or by an additive sol-gel process as described in U.S. Pat. No. 5,725,957 (Catherine Getz and D. Varaprasad of the Donnelly Corporation, Holland, Mich.), the disclosure of which is incorporated by reference herein.

Other variations and modifications of this invention will be obvious to those skilled in the art. For example, a polymeric substrate such as a polycarbonate face plate can be used with suitable modification after coating chemically to facilitate low temperature (less than 200° C. preferred) firing to form the abrasion resistant coating. This invention is not limited except as set forth in the claims.

What is claimed is:

1. A method for forming a protective multicomponent coating on a substrate, said method comprising the steps of:
(a) applying a coating solution to the substrate, said coating solution comprising
(i) a coating solvent;
(ii) a SiO₂ precursor comprising a silicon compound having at least one hydrolyzable group;
(iii) a glass oxide precursor comprising a compound having an element selected from Group III or Group IV of the periodic table in the form of a salt, an alkoxide, a hydroxide or an acid thereof; and
(iv) a network modifier precursor comprising a compound containing an element selected from Group I or Group II of the periodic table; and
(b) subsequently firing the substrate at a temperature effective to form the protective multicomponent coating on the substrate.

2. A method according to claim 1, wherein said network modifier precursor is in the form of a hydroxide, an acetate or an alkoxide.

3. A method according to claim 2, wherein said temperature is greater than 450° C.

4. A method according to claim 1, wherein said SiO₂ precursor comprises at least one compound of the general formula R′ₙSi(OR)₄₋ₙ, where R is an alkyl group, R′ is an alkyl group or an aryl group, and n is a number between 1 and 3, inclusive.

5. A method according to claim 4, wherein said SiO₂ precursor comprises at least one compound of the general formula SiX₄, where X is halide, an acetoxy, an alkoxy, or an aryloxy group.

6. A method according to claim 1, wherein said SiO₂ precursor comprises at least one compound of the general formula YₙSi(Z)₄₋ₙ, where Y is an alkyl group, an aryl group, or a non-hydrolyzable group, Z is halide, an alkoxy group, an aryloxy group, —OCOR, —NR₂, —OC(═CH₂)R, and —ON═CR₂, R being an alkyl or an aryl group, and n is a number between 1 and 3, inclusive.

7. A method according to claim 1, wherein the element selected from Group III or Group IV of the periodic table comprises B or Al.

8. A method according to claim 1, wherein the element selected from Group I or Group II of the periodic table comprises Li, Na, or K.

9. A method according to claim 1, wherein the SiO₂ precursor comprises CH₃Si(OCH₃)₃ or CH₃Si(OCH₂CH₃)₃.

10. A method according to claim 1, wherein the SiO₂ precursor comprises at least two different silicon compounds each having at least one hydrolyzable substituent.

11. A method according to claim 1, wherein the glass oxide precursor comprises B(OH)₃ or B(OC₂H₅)₃.

12. A method according to claim 1, wherein the glass oxide precursor comprises a chelated aluminum alkoxide.

13. A method according to claim 10, wherein the chelated aluminum alkoxide comprises Al(OⁱC₃H₇)₂C₆H₉O₃.

14. A method according to claim 1, wherein said protective coating comprises Al₂O₃, B₂O₃, and SiO₂.

15. A method according to claim 14, wherein said protective coating further comprises at least one of Li₂O and Na₂O.

16. A method according to claim 14, wherein the content of SiO₂ in said protective coating is greater than 50 wt. %.

17. A method according to claim 15, wherein the content of Li₂O and Na₂O combined in said protective coating is less than 20 wt. %.

18. A method according to claim 14, wherein the content of B₂O₃ in said protective coating is less than 30 wt. %.

19. A method according to claim 14, wherein the content of Al₂O₃ in said protective coating is less than 20 wt. %.

20. A method according to claim 1, wherein the coating solvent comprises at least one member selected from the group consisting of an alcohol, ester, ketone, and hydrocarbon.

21. A method according to claim 1, wherein the coating solvent comprises at least two members selected from the group consisting of an alcohol, ester, ketone, or hydrocarbon, wherein the selected members have different boiling points.

22. A method according to claim 1, wherein the coating solvent comprises at least one additive selected from the group consisting of a surfactant, defoamer, air release additive, flow aid, and viscosifier.

23. A method according to claim 1, wherein the substrate is a cathode ray tube face-plate.

24. A method according to claim 1, wherein the substrate is a flat overlay for a liquid display application.

25. A method according to claim 1, wherein the substrate is used as a touch screen.

26. A substrate with a protective multicomponent coating, said coating formed by a process comprising the steps of:
(a) applying a coating solution to the substrate, said coating solution comprising
(i) a coating solvent;
(ii) a SiO₂ precursor comprising a silicon compound having at least one hydrolyzable group;
(iii) a glass oxide precursor comprising a compound having an element selected from Group III or Group IV of the periodic table in the form of a salt, an alkoxide, hydroxide or an acid thereof; and
(iv) a network modifier precursor comprising a compound containing an element selected from Group I or Group II of the periodic table in the form of a hydroxide, an acetate, or an alkoxide thereof; and
(b) subsequently firing the substrate at a temperature greater than 450° C. to form the protective multicomponent coating on the substrate.

27. A multicomponent coating solution comprising:
(i) a coating solvent;
(ii) a SiO₂ precursor comprising a silicon compound having at least one hydrolyzable group;
(iii) a glass oxide precursor comprising a compound having an element selected from Group III or Group IV of the periodic table in the form of a salt, an alkoxide, a hydroxide or an acid thereof; and
(iv) a network modifier precursor comprising a compound containing an element selected from Group I or Group II of the periodic table.

28. A coating solution according to claim 27, wherein said SiO₂ precursor comprises at least one compound of the general formula R′ₙSi(OR)₄₋ₙ, where R is an alkyl group, R′ is an alkyl group or an aryl group, and n is a number between 1 and 3, inclusive.

29. A coating solution according to claim 28, wherein said SiO₂ precursor comprises at least one compound of the general formula SiX₄, where X is halide, an acetoxy, an alkoxy, or an aryloxy group.

30. A coating solution according to claim 27, wherein said SiO₂ precursor comprises at least one compound of the general formula YₙSi(Z)₄₋ₙ, where Y is an alkyl group, an aryl group, or non hydrolyzable group, Z is halide, an alkoxy group, an aryloxy group, —OCOR, —NR₂, —OC(═CH₂)R, and —ON═CR₂, R being an alkyl or an aryl group, and n is a number between 1 and 3, inclusive.

31. A coating solution according to claim 27, wherein the element selected from Group III or Group IV of the periodic table comprises B or Al.

32. A coating solution according to claim 27, wherein the element selected from Group I or Group II of the periodic table comprises Li, Na, or K.

33. A coating solution according to claim 27, wherein the SiO₂ precursor comprises CH₃Si(OCH₃)₃ or CH₃Si (OCH₂CH₃)₃.

34. A coating solution according to claim 27, wherein the SiO₂ precursor comprises at least two different silicon compounds each having at least one hydrolyzable substituent.

35. A coating solution according to claim 27, wherein the glass oxide precursor comprises B(OH)₃ or B(OC₂H₅)₃.

36. A coating solution according to claim 27, wherein the glass oxide precursor comprises a chelated aluminum alkoxide.

37. A coating solution according to claim 36, wherein the chelated aluminum alkoxide comprises Al(Oⁱ C₃H₇)₂C₆H₉O₃.

38. A coating solution according to claim 27, wherein said network modifier precursor is in the form of a hydroxide, an acetate or an alkoxide.

39. A coating solution according to claim 27, wherein the coating solvent comprises at least one member selected from the group consisting of an alcohol, ester, ketone, and hydrocarbon.

40. A coating solution according to claim 27, wherein the coating solvent comprises at least two members selected from the group consisting of an alcohol, ester, ketone, or hydrocarbon, wherein the selected members have different boiling points.

41. A coating solution according to claim 27, wherein the coating solvent comprises at least one additive selected from the group consisting of a surfactant, defoamer, air release additive, flow aid, and viscosifier.

42. A coating solution according to claim 27, further comprising non-soluble particles in an amount effective to modify at least one optical or electrical property of a coating prepared from said coating solution.
